(19) United States
(12) Patent Application Publication
(10) Pub. No.: US 2012/0200999 A1
(43) Pub. Date: Aug. 9, 2012

(54) MOBILE COMPUTING DEVICE WITH MOVEABLE HOUSING SEGMENTS

(76) Inventor: Livius CHEBELEU, San Jose, CA (US)

(21) Appl. No.: 13/172,160

(22) Filed: Jun. 29, 2011

Related U.S. Application Data
(60) Provisional application No. 61/440,344, filed on Feb. 7, 2011.

(51) Int. Cl. G06F 1/16

(52) U.S. Cl. 361/679.55

(57) ABSTRACT

An extension slider assembly for a computing device to interconnect at least two housing segments. The extension slider assembly includes (i) a first moving structure that is engaged to move relative to one of the at least two housing segments in order to provide freedom for the at least two housing segments to move between one of the closed or open position and an intermediate position; and (ii) a second moving structure that is engaged to move relative to the first moving structure in order to provide freedom for the at least two housing segments to move between the intermediate position and the other of the open or closed position.

### RELATED APPLICATIONS

This application claims the benefit of priority under 35 U.S.C. 119(e) to Provisional Application Ser. No. 61/440,344, filed Feb. 7, 2011, titled MOBILE COMPUTING DEVICE WITH MOVEABLE HOUSING SEGMENTS, which is incorporated herein by reference in its entirety.

### TECHNICAL FIELD

The disclosed embodiments relate generally to the field of housings for mobile computing devices. In particular, embodiments described herein pertain to a mobile computing device that has a housing construction with moveable housing segments.

### BACKGROUND

Over the last several years, the growth of cell phones and messaging devices has increased the need for keypads and button/key sets that are small and tightly spaced. In particular, small form-factor keyboards, including QWERTY layouts, have become smaller and more tightly spaced. With decreasing overall size, there has been greater focus on efforts to provide functionality and input mechanisms more effectively on the housings.

In addition to a keyboard, mobile computing devices and other electronic devices typically incorporate numerous buttons to perform specific functions. These buttons may be dedicated to launching applications, short cuts, or special tasks such as answering or dropping phone calls. The configuration, orientation and positioning of such buttons is often a matter of concern, particularly when devices are smaller.

At the same time, there has been added focus to how displays are presented, particularly with the increased resolution and power made available under improved technology. Moreover, form factor consideration such as slimness and appearance are important in marketing a device.

Production of mobile computing devices is made more difficult in the fact that conventional devices use many parts or components. The housing for a typical conventional mobile computing device typically includes a top shell, a back shell, and a midframe. The components that comprise the contents of the housing, such as printed circuit boards and display assemblies, normally require additional assembly steps. Many devices include additional housing features that are provided on the device separately. The result is that the devices often have numerous interconnected components. In the case of the housing, the numerous components yield devices that are less durable and more difficult to assemble.

In order to increase the features and functionality on a computing device, many mobile computing devices employ a sliding construction between two segments of the housing. Typically, in a sliding construction, the housing of a computing device is separated into two distinct parts that are coupled to one another to slide. The parts of the housing can be extended or contracted, to reveal functionality and/or adjust the overall size of the computing device.

### BRIEF DESCRIPTION OF THE DRAWINGS

FIG. 1A through FIG. 1C illustrate a mobile computing device that includes a housing construction that incorporates an extension slider, according to one or more embodiments.

FIG. 2 is an isometric and exploded view of a housing for a mobile computing device, according to an embodiment.

FIG. 3 is a frontal view of a top plate of the housing assembly connected to a base plate, according to an embodiment.

FIG. 4 is a cross-sectional view of the portion of the housing assembly as cut along lines A-A, under an embodiment.

FIG. 5 is an isolated view of a carriage, according to an embodiment.

### DETAILED DESCRIPTION

A mobile computing device housing assembly is provided that uses an extension slider mechanism to maximize the extension length of the housing as compared to the overall length of the slider. Among other benefits, a mobile computing device may be constructed to have a slider form factor, with proportionately more housing surface that can be exposed (given device overall dimensions) as compared to more conventional approaches.

According to one or more embodiments, a mobile computing device includes at least two housing segments that are slidably coupled to one another to move between a closed position and an open position. The mobile computing device includes an extension slider assembly to interconnect at least two housing segments. The extension slider assembly includes a first moving structure that is engaged to move relative to one of the at least two housing segments in order to provide freedom for the at least two housing segments to move between one of the closed or open position and an intermediate position. Additionally, the extension slider assembly includes a second moving structure that is engaged to move relative to the first moving structure in order to provide freedom for the at least two housing segments to move between the intermediate position and the other of the open or closed position.

Embodiments described herein provide for a mobile computing device that is constructed of moveable housing segments. Still further, another embodiment provides that housing segments of the mobile computing devices are moveable along a path of motion that is continuously arced.

With regard to some quantitative expressions used herein, the expression “substantially all” means 90% or more. Furthermore, the term “majority” means at least 50% more than 50% of a stated quantity or comparison.

Overview

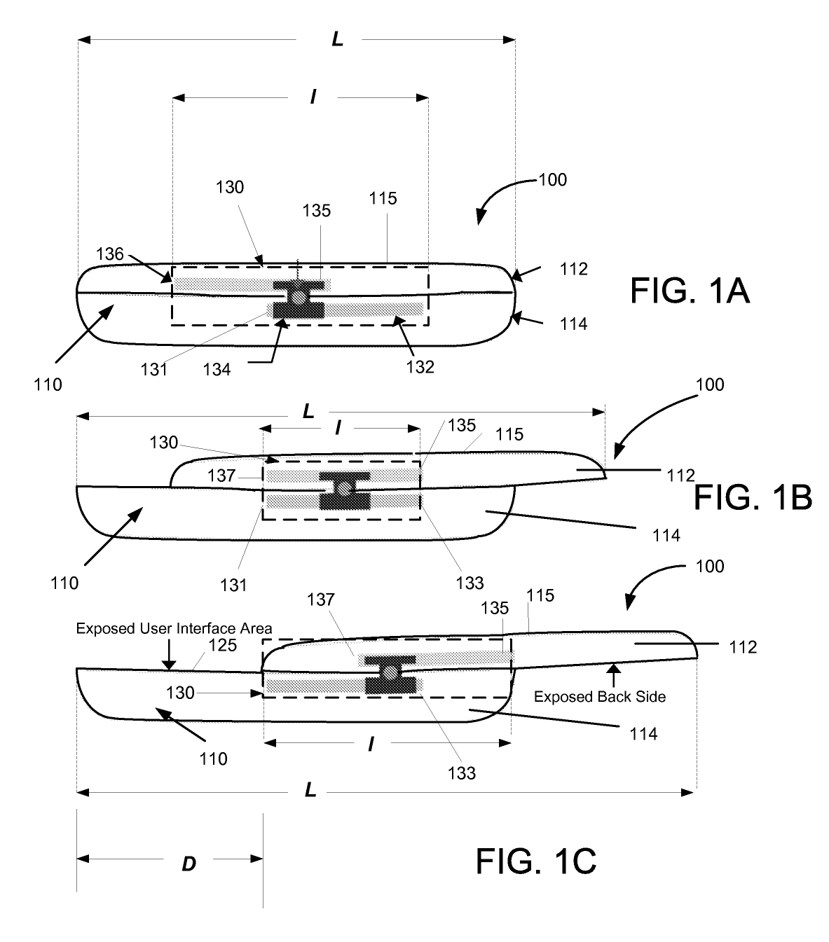

FIG. 1A through FIG. 1C illustrate a mobile computing device that includes a housing construction that incorporates an extension slider assembly, according to one or more embodiments. A mobile computing device 100 is constructed from a housing 110 that includes a top segment 112 and a bottom segment 114. An extension slider assembly 130 moveably couples the housing segments 110, 112 between open and closed orientations in order to expose additional user-interface features and/or functionality. In contrast to conventional approaches, the extension slider assembly 130 incorporates a slider engagement on another slider engagement in order to enable the device to achieve full extension. Among other benefits, the extension slider assembly 130 can incorporate rail structures and other longitudinal engagement structures that have lengths that are less than the overall length that can be achieved between closed and open orientations (i.e. at full extension).

In more detail, FIG. 1A illustrates the housing segments 110, 112 of the mobile computing device 100 in a closed orientation. In the closed orientation, the top segment 112 completely overlays the bottom segment 114. In some implementations, top segment 112 includes a display surface 115 and other user-interface features (e.g. buttons, sensors, touch-screen or area, microphone, speaker). The device may be operational in one or more modes when closed. For example, the device may be operated as a telephony device, picture viewer, web browser etc. In implementations when the bottom segment 112 includes a keyboard (provided on keyboard area 125), the closed orientation may be used to provide virtual keyboards or buttons to facilitate user operation.

FIG. 1B illustrates the housing segments 112, 114 moved into a partially open orientation. In this orientation, an underlying surface 125 or feature of the bottom housing segment 114 is partially exposed.

FIG. 1C illustrates the housing segments moved into an open position. The underlying surface 125 of the bottom segment 114 is fully exposed. In one implementation, a keyboard, for example, may be provided on the bottom segment 114. Other input mechanisms, user-interface features and functionality can also or alternatively be provided.

With reference to FIG. 1A through FIG. 1C, the slider assembly 130 can be embedded within the housing 110. In some implementations, the slider assembly 130 can be provided as a single structure, such as one positioned in the center region (relative to peripheral edges) of the housing. In another implementation, the slider assembly 130 (or multiple slider assemblies) are provided at peripheral regions or surfaces of the housing 110.

In an embodiment, the extension slider assembly 130 includes a rail 132, a first moving structure 134, and a second moving structure 136. The rail 132 may include a slot and/or protrusion to enable another structure to slide along its length. The rail 132 may also be fixed relative to one housing of the housing segments 112, 114 (shown fixed to bottom segment). For example, rail 132 may be formed from an integral or affixed component of a housing plate or component that is provided as part of the bottom housing segment 114. According to some embodiments, the first moving structure corresponds to a carriage that is slidably or moveably engaged with the rail 132 and/or second moving structure 136. The second moving structure 136 can include a rail and/or housing structure that is captured (or captures) the first moving structure 134 (e.g. rail). The first moving structure 134 is slidably engaged to the rail 132 to move along the rail 132. The first and second moving structures 134, 136 are also coupled to enable the second moving structure 136 to move relative to the first moving structure 134.

In the closed orientation shown by FIG. 1A, the first moving structure 134 is engaged to (i) the rail structure 132 at its south end 131, and (ii) the second moving structure 136 at its north end 135. An overall length (l) of the rail assembly 130 is at a maximum, while an overall length (L) of the device 100 is at a minimum. Movement of the housing segments 112, 114 from closed to open orientation coincides with the first moving structure 134 moving northward relative to the rail structure 132, and southward relative to the second moving structure 136.

In the partially open orientation shown by FIG. 1B, the second moving structure 136 overlays the rail structure 132. The overall length (l) of the rail assembly 130 is at a minimum, while overall length (L) of the device 100 is increased. The first moving structure 134 is engaged with each of the rail structure 132 and second moving structure 136 at their respective mid-sections (between respective north ends 133, 135 and south ends 131, 137).

In the open orientation shown by FIG. 1C, the first moving structure 134 is engaged to (i) the rail structure 132 at its north end 133, and (ii) the second moving structure 136 at its south end 137. The overall length (l) of the rail assembly 130 is at a maximum, and the overall length (L) of the device 100 is at a maximum. In the implementation shown, the housing segments 112, 114 translates a relative distance D between the open and closed orientations, which is equivalent to the sum of (i) the amount translated by the first moving structure 134 about the rail 132, and (ii) the amount translated by the second moving structure 136 about the first moving structure.

Among other benefits, the extension rail assembly 130 occupies a smaller length (critical dimension) than would otherwise be needed with a conventional approach (e.g. carriage and rail structure). In particular, the overall length (l) of the rail assembly 130 when in the open/closed position is less than the portion of the device length (L) that is overlapped by the top and bottom segments 112, 114. Under this dimensional constraint, the rail assembly 130 can be used to achieve an extension length that is greater than the maximum overall length of the rail assembly 130. More specifically, in one embodiment, one result that can be achieved with use of an extension slider is that a ratio R of (i) an overall distance of motion of two housing segments coupled by the extension slider, over (ii) a length required by the extension slider assembly 130 is greater than 1 (1<R≦2). In this regard, R is significantly greater than would otherwise be achieved through conventional approaches in which sliders incorporate one moving structure over a rail. Such construction enables the housing dimensions of a mobile computing device to be minimized further, particularly as the region in which two housing segments are to overlap when the housing segments are in open and closed orientations.

Housing Assembly for Mobile Computing Device

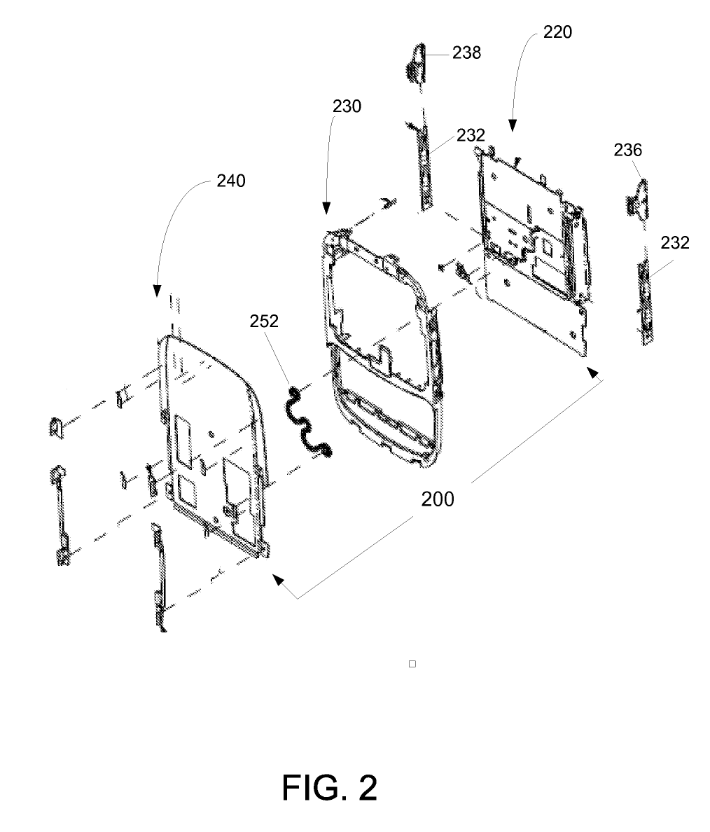

FIG. 2 through FIG. 5 illustrates a mobile computing device and housing which incorporates an extension slider assembly, according to one or more embodiments.

FIG. 2 is an isometric and exploded view of a housing assembly for a mobile computing device, according to an embodiment. More specifically, a housing assembly 200 for a mobile computing device (not shown) comprises of a base plate 220, a mid-frame 230, and a top plate 240. An extension slider assembly is distributed by components on base plate 220 and top plate 240. The extension slider assembly enables the top plate 240, 232 to slide relative to the base plate 220. The mid-frame 230 may encapsulate around a portion of base plate 220 and top plate 240. Additional structures may envelop the base plate 220, top plate 240 to form the mobile computing device housing.

Components of the extension slider assembly include a first peripheral rail 232 and a second peripheral rail 234, provided on peripheral edges of the base plate 220. The peripheral rails 232, 234 are molded, or otherwise shaped to provide a protruding length that extends vertically along the respective peripheral edge of the base plate 220. A carriage 236, 238 engages each of the peripheral rails 232, 234. Each carriage 236, 238 capture the respective protrusion of the corresponding peripheral rail 232, 234, so that each carriage is able to slide a length of the respective rail (shown to be the vertical direction). Each carriage 236, 238 is structured to capture the top plate 240 and a corresponding peripheral edge of the top plate. In this way, the carriages 236, 238 are able to slide relative to the top plate 240, as well as relative to the base plate 220. A dual sliding engagement is provided between the carriages 236, 238 and the respective top plates 240 and base plates 220.

According to some embodiments, one or more springs 252 are provided to bias the base plate 220 and top plate 240 in moving towards or away from open and closed orientations. The use of springs enables creation of, for example, non-stable intermediate positions, in order to enable respective segments of the formed housing to snap in one of the stable (e.g. open or closed) orientations.

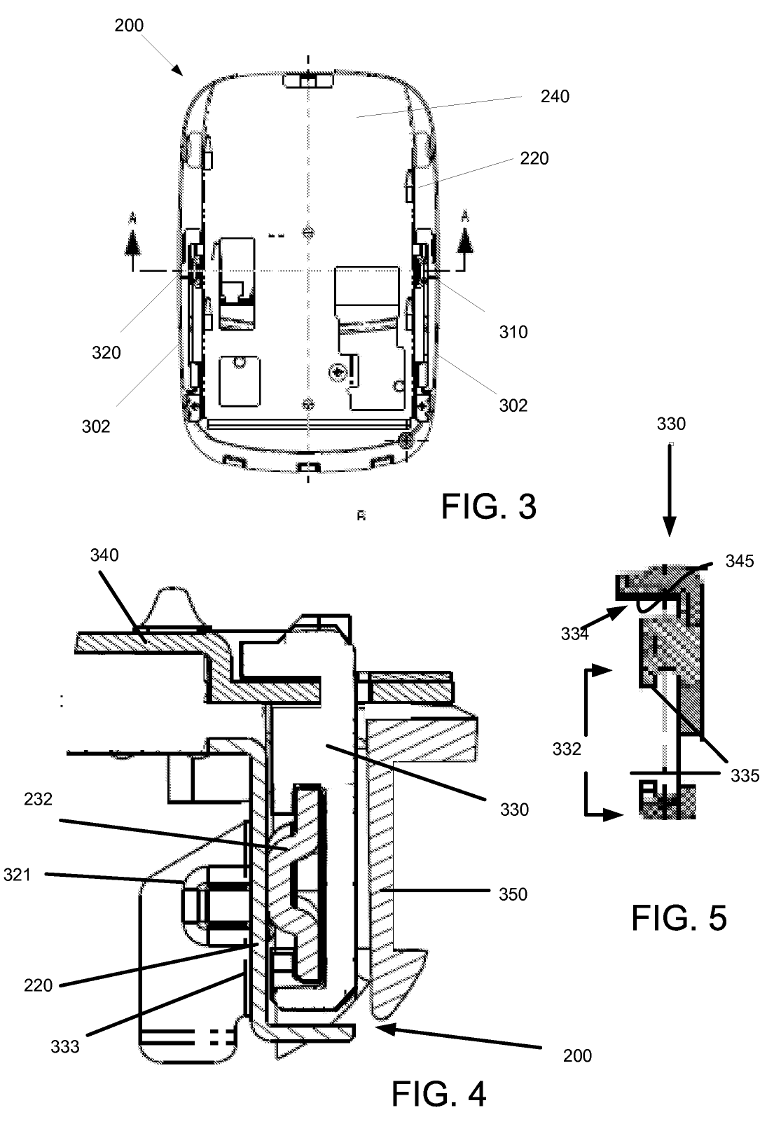

FIG. 3 is a frontal view of top plate 240 of the housing assembly connected to the base plate 220, according to an embodiment. The midframe 230 (not shown in FIG. 3) may be disposed between the top plate 240 and the base plate 220. In the example shown by FIG. 3, the housing assembly 200 is in the closed orientation. The extension slider assembly 300 is formed by multiple slider structures 310, 320, provided at each lateral sides 302, 302 of the combined structure formed by the top plate 240 and the base plate 220. As described with FIG. 2, the slider structures include carriages that are each connected to a fixed rail and the top plate 240. FIG. 5 illustrates additional details of the slider structures 310, 320.

FIG. 4 is a cross-sectional view of the portion of the housing assembly as cut along lines A-A, under an embodiment. The cross section illustrates slider structures 310 of the extension slider assembly 200 (see FIG. 3). At the section shown by A-A, the rail 232 is connected to the base plate 220. A fastener 321 may be used to connect the base plate 220 and the rail 232. Alternatively, the rail 232 may be provided as a single piece structure with the base plate 220. The rail 232 is secured to a sidewall 333 of the base plate 220, resulting in the base plate 220 having an L-shape cross-section (as viewed vertically). A carriage 330 is provided about the rail 232 to slide vertically (into paper). A second fixed rail 340 is attached to the base plate 220 and combines with the carriage to provide a capture structure for the top plate 240. The top plate 240 is captured by the carriage 330. In this way, the top plate is able to slide relative to the carriage 330, and the carriage is able to slide relative to the rail 232. The extension slider assembly is thus formed by the slider engagements of the carriage 330 with respect to rail 232 and the top plate 240. Additional exterior structures 350 may be provided to embed the slider structure partially within the housing assembly.

FIG. 5 is an isolated view of the carriage 330, according to an embodiment. The carriage 330 includes a first capture structure 332 to retain the rail 232. The first capture structure 332 is formed by members 335, 335 that are shaped to slidably engage the rail 232. The members 335 may be doglegged or bent in order to slide about and capture edge sections of the rail which protrude from the surface the base plate 220. Additionally, the carriage 330 includes a second capture structure 334 to the top plate 240 (See FIG. 3). The second capture structure 334 includes a shaped cavity 345 that receives the edge section of the top plate 240. The second fixed rail 340 (FIG. 4) may facilitate retention of the top plate within the shaped cavity 345.

Although illustrative embodiments have been described in detail herein with reference to the accompanying drawings, it is to be understood that embodiments are not to be limited to those as exactly described. Specifically, many modifications and variations will be apparent to practitioners skilled in this art. Accordingly, it is intended that the scope of the invention be defined by the claims and their equivalents (whenever presented). Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A mobile computing device comprising:
at least two housing segments that are slidably coupled to one another to move between a closed orientation and an open orientation;
an extension slider assembly to interconnect the at least two housing segments, the extension slider assembly including (i) a first moving structure that is engaged to move relative to one of the at least two housing segments in order to provide freedom for the at least two housing segments to move between one of the closed or open orientation and an intermediate orientation; and (ii) a second moving structure that is engaged to move relative to the first moving structure in order to provide freedom for the at least two housing segments to move between the intermediate orientation and the other of the open or closed orientation.

2. The mobile computing device of claim 1, wherein the extension slider assembly includes (i) a rail provided on one of the at least two housing segments, and (ii) a carriage as the first moving structure, the carriage being slidably coupled to the rail.

3. The mobile computing device of claim 2, wherein the extension slider assembly includes a second moving structure that is slidably coupled to the carriage to move relative to the carriage.

4. The mobile computing device of claim 3, wherein the second moving structure is a housing plate.

5. The mobile computing device of claim 3, wherein the carriage includes a first capture structure to slidably engage the rail, and a second capture structure to engage the second moving structure.

6. The mobile computing device of claim 5, wherein the carriage is formed from a single piece.

7. The mobile computing device of claim 5, wherein the first capture structure of the carriage includes a base structure and a pair of doglegged extensions that extend to capture a shaped section of the rail.

8. The mobile computing device of claim 5, wherein the second capture structure of the carriage includes a cavity that receives a section of the second moving structure.

9. The mobile computing device of claim 8, further comprising a fixed structure that is positioned apart from the carriage to retain the second of the second moving structure within the cavity of carriage.

10. A mobile computing device comprising:
a first housing segment;
a second housing segment;
one or more slider assemblies that moveably couple the first housing segment to the second housing segment;
wherein each of the one or more slider assemblies includes:
a rail provided with the first housing segment;
a carriage coupled to the rail to move along the rail between a first position corresponding to the first and second housing segments being closed, and a second position corresponding to the first and second housing segments being partially opened;
a housing structure provided with the second housing segment and moveably coupled to the carriage to move, relative to the carriage, between a third position corresponding to the first and second housing segments being partially opened, and a fourth position corresponding to the first and second housing segments being opened.

11. The mobile computing device of claim 10, wherein the housing structure is coupled to translate a first length when the first and second housing segments are moved from being closed to being opened, as a result of (i) the carriage moving half the first length when moving between the first position and the second position, and (ii) the housing structure moving approximately half the first length when moving between the third position and the fourth position.

12. The mobile computing device of claim 10, wherein the carriage includes a bearing wheel to interconnect the housing structure to the rail.

13. The mobile computing device of claim 10, further comprising a first slider assembly provided at a first peripheral section of the mobile computing device, and a second slider assembly provided at a second peripheral section of the mobile computing device.

14. The mobile computing device of claim 10, wherein the housing structure is coupled to the carriage.
